(19) United States
(12) Patent Application Publication
(10) Pub. No.: US 2006/0136256 A1
(43) Pub. Date: Jun. 22, 2006

(54) Publish/subscribe messaging system

(76) Inventors: Jamie Gavin Roots, Chandlers Ford (GB); Stephen James Todd, Winchester (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/301,674

(22) Filed: Dec. 13, 2005

(30) Foreign Application Priority Data
Dec. 18, 2004 (GB) 0427798.4

(51) Int. Cl. G06Q 99/00

(52) U.S. Cl. 705/1

(57) ABSTRACT

A broker determines that a publication received from a publisher is transmitted to at least one subscriber. When a publication is received from a publisher, it is determined whether there are any subscribers registered as interested in the received publication. The received publication is retained in storage at least until the publication is delivered successfully to a subscriber in response to determining that there are no registered subscribers for the received publication.

### BACKGROUND OF THE INVENTION

The present invention relates to loading resources in software applications, and more particularly, to detecting stale cached resources.

Existing messaging products such as the IBM® WebSphere® MQ family, SonicMQ, and embedded Java™ Messaging Service (JMS) support within J2EE Application Servers such as WebSphere Application Server and BEA® WebLogic®, support two styles of messaging: point-to-point and publish/subscribe (IBM and WebSphere are trademarks of International Business Machines in the United States, other countries or both, BEA and WebLogic are trademarks of BEA in the United States, other countries or both, and Java is a trademark of Sun Microsystems in the United States, other countries, or both). These two styles of messaging are described, for example, in the JMS specification, which can be found at http://java.sun.com/products/jms/docs.html.

In point-to-point store-and-forward messaging, a message recipient is described as arbitrating, in that, for each received message, the recipient selects a single consumer to receive the message. A point-to-point recipient is also retentive, meaning that messages produced when there are no consumers attached are retained for delivery to consumers that subsequently attach. The problem with point-to-point is that a considerable amount of pre-configuration is required: Each pair of applications that wish to communicate must agree on a unique destination that they will use, and a recipient must be configured to use this destination, of which there will be up to nˆ2 in a network with n applications.

Publish/subscribe data processing systems have become very popular in recent years as a way of distributing data messages. Publishers are typically not concerned with where their publications are going, and subscribers are typically not interested in where the messages they receive have come from. Instead, a message broker typically assures the integrity of the message source, and manages the distribution of the message according to the valid subscriptions registered in the broker.

Publishers and subscribers may also interact with a network of brokers, each one of which propagates subscriptions and forwards publications to other brokers within the network. Therefore, when the term “broker” is used herein it should be taken as encompassing a single broker or multiple brokers working together as a network to provide brokering services.

An overview of a typical pub/sub system is described with reference to FIG. 1. Such a system comprises a number of publishers 10, 20, 30 publishing messages to a broker 70 on particular topics (e.g. news, weather, sport). Subscribers 40, 50, 60 register their interest in such topics via subscription requests received at the broker 70. For example, subscriber 40 may request to receive any information published on the weather, whilst subscriber 50 may desire information on the news and sport.

Note, broker 70 might be an identifiable process, set of processes or other executing component, or instead might be “hidden” inside other application code. The logical function of the broker will however exist somewhere in the network. When broker 70 receives a message on a particular topic from a publisher, the broker determines from its list of subscriptions to whom that message should be sent. The broker then transmits the message to such subscribers.

Thus the key advantage of publish/subscribe is clearest when considering messaging between a large set of publishers and a large set of subscribers (as is commonly the case in real messaging deployments). With publish/subscribe, because messages are delivered to each matching subscriber, no pre-configuration of message routing is required. Instead, all applications can connect to a single well-known publish/subscribe destination, which provides a “broker” capability, matching each consumer's subscription request to the messages produced.

Message system clustering is also known. In such a situation, multiple queues are given the same proxy name (x). A client puts a message to queue x and behind the scenes the message is put to any one of the queues representing x. If none of the registered queues representing x are available then, the message will be held on a transmission queue until a transmission destination is available. WebSphere MQ Clustering is described at: http://publibfp.boulder.ibm.com/epubs/pdf/csqzah06.pdf.

Note, it is known to use heartbeats to determine the existence of an active system. See for example http://www.javaworld.com/javaworld/jw-03-2002/jw-0315-heart.html? (e.g. a publisher) and it is also known to make liveness requests. See http://www.jaist.ac.jp/˜defago/files/pdf/FDG+99.pdf.

### BRIEF SUMMARY OF THE INVENTION

According to a first aspect of the present invention, a method for a broker to assure that a publication received from a publisher is transmitted to at least one subscriber comprises receiving a publication from a publisher, and retaining the publication in storage at least until the publication is delivered successfully to a subscriber in response to determining that there are no registered subscribers for the received publication.

According to another aspect of the present invention, an apparatus for a broker to assure that a publication received from a publisher is transmitted to at least one subscriber comprises means for receiving a publication from a publisher, and means for retaining the publication in storage at least until the publication is delivered successfully to a subscriber in response to determining that there are no registered subscribers for the received publication.

According to yet another aspect of the present invention, a computer program product for a broker to assure that a publication received from a publisher is transmitted to at least one subscriber program product comprises a computer usable medium having computer useable program code embodied therewith. The computer useable program code comprises computer usable program code configured to receive a publication from a publisher, and computer usable program code configured to retain the publication in storage at least until the publication is delivered successfully to a subscriber in response to determining that there are no registered subscribers for the received publication.

Other aspects and features of the present invention will become apparent to those ordinarily skilled in the art or science to which it pertains upon review of the following description in conjunction with the accompanying figures.

### BRIEF DESCRIPTION OF THE SEVERAL VIEWS OF THE DRAWINGS

FIG. 1 shows an overview of a typical publish/subscribe messaging system according to the prior art;

FIG. 2 illustrates the components provided by a broker according to an aspect of the present invention;

FIGS. 3a and 3b shown the processing of an aspect of the present invention upon receipt of a publication and a subscription request respectively;

FIG. 4 shows a hierarchy of brokers in accordance with an aspect of the present invention; and

FIGS. 5a and 5b show the components and processing of an optimization of the present invention in accordance with one embodiment.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-usable or computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

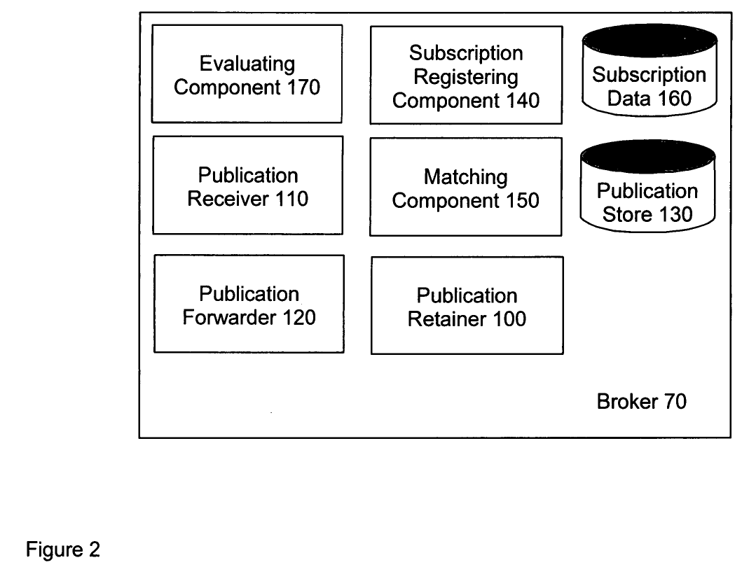

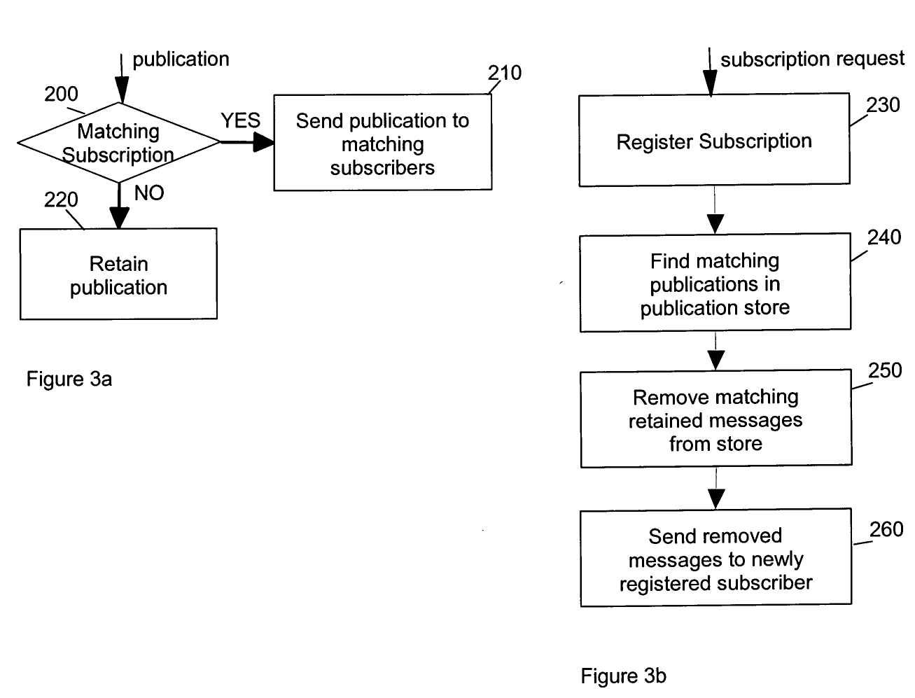

FIGS. 2, 3a and 3b illustrate the componentry and processing of the present invention. They should all be read in conjunction with one another.

A broker 70 receives a publication via publication receiver 110. A matching component 150 determines whether there are any matching subscribers (step 200) and if there are, the publication is forwarded by the publication forwarder 120 to those matching subscribers (step 210). If however there are no matching subscribers, then the publication is retained by publication retainer 100 in publication store 130 (step 220).

This is atypical of the way in which publish subscribe normally works. This is because publications are typically received by a publish/subscribe broker and are then distributed to registered subscribers. Generally, a received publication is not stored unless for the reasons discussed in the background section.

The other part of the process may be triggered by the registration of a new subscriber. Broker 70 receives a subscription request and registers this (subscription registering component 140) as subscription data 160 (step 230). An evaluating component 170 at the broker then looks for publications in publication store 130 which match the recently received subscription request (step 240). Such matching publications are then removed from the publication store 130 (step 250) are then forwarded by publication forwarder 120 to the newly registered subscriber (step 260).

In this way, broker 70 assures that a publication will always be received by at least one subscriber. Of course, the process described with reference to FIGS. 3a and 3b is an aspect only. Various modifications are also possible. For example, the evaluating component may not perform step 240 every time a new subscriber registers. Instead, the evaluating component may determine whether there are any matching publications on a periodic basis. The problem with this approach is that matching publications will be forwarded onto any subscribers whose subscription request matches. This could be five, ten, or five hundred. Of course, from a fail safe point of view, such a publication may be sent to more than one subscriber.

In accordance with an aspect, the present invention can also be implemented in a distributed, non-localised, environment. A publish/subscribe system may comprise a network of multiple brokers. In such a system, no particular broker within the network plays a special role. Instead, multiple brokers cooperate to distribute each publication produced to all registered subscribers. The details of how this is done vary depending on the implementation.

A highly simplified version of the subscription propagation scheme employed in the WebSphere MQ family of products will now be described. Consider a network of brokers connected by network links so as to form a free tree hierarchy (Knuth, “The Art of Computer Programming”, Volume 1, Third Edition, p. 363). Publishers and subscribers may attach at arbitrary points in the hierarchy. When a subscriber registers with a subscription request, its interest in publications matching the subscription, is communicated from the broker to which it has attached, to all the other brokers in the network. The subscription request is propagated along the path defined by the oriented tree (Knuth, p. 373) rooted at the broker to which it has attached. Each broker maintains a data structure recording the subscriptions it has received. When a publication is published, it is compared against subscription data held at each broker and is delivered to subscribers with matching subscriptions, following the reverse path to that of the original subscription request itself.

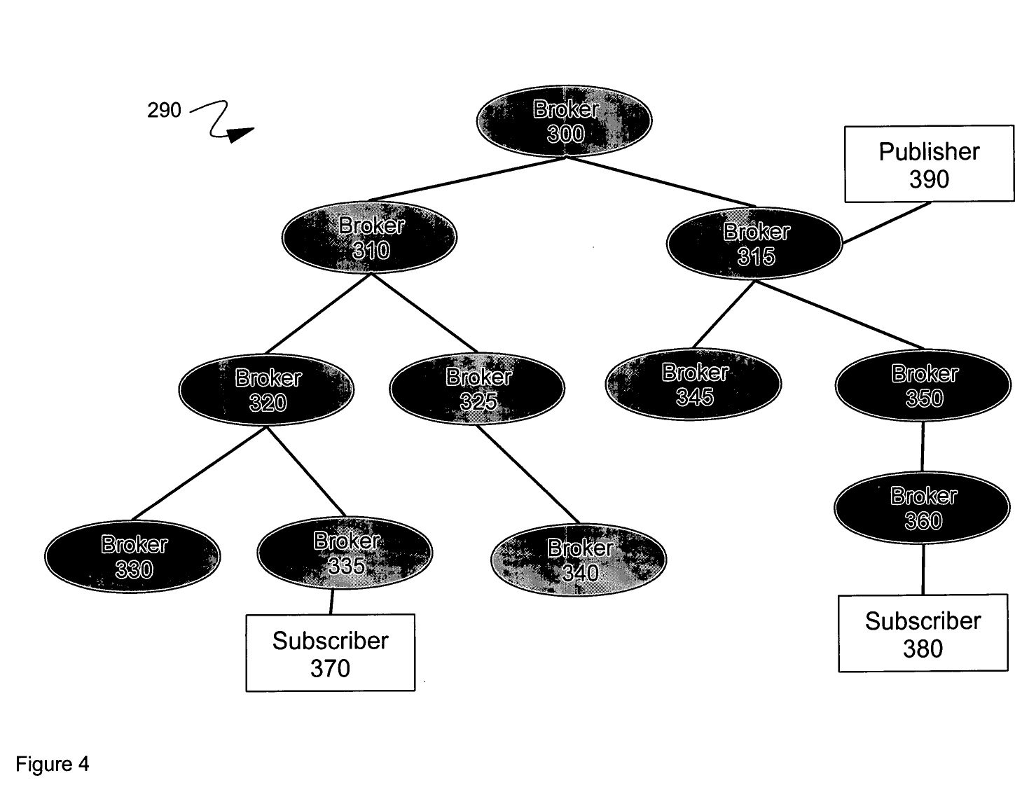

Thus the solution described with reference to FIGS. 2, 3a and 3b may also work in the distributed environment. FIG. 4 shows a publish/subscribe broker hierarchy in accordance with an aspect of the present invention. As discussed above, a network 290 comprises a plurality of brokers 300 . . . 360. Publishers 390 may attach to any broker in the network and likewise, subscribers 370, 380 may also attach to any broker in the network. Brokers then cooperate to propagate subscription requests to the broker network. For example, subscriber 370 may indicate an interest in publications on topic A by providing a subscription request to its local broker 335. Broker 335 informs broker 320 that it wants to know about publications on topic A. Broker 320 informs brokers 310 and 330 that it wants to hear about publications on topic A and so on. In this way, when publisher 390 publishes on topic A to its local broker 315, this publication will get forwarded through the broker network 290 to subscriber 370.

In the case of the distributed solution, each broker implements the following pseudo-code:

```
// This method is invoked when a publisher or another broker sends/
forwards on a publication
  Destination.send(publication m)
    if SubscriptionSet is empty
      put m in PublicationStore
    otherwise
      for all (subscriber s , subscription_data sd) in SubscriptionSet
        if m matches sd
          send m to s
```

A publication m is received at a broker. The broker determines whether any subscribers have registered an interest in publications of the type just received (SubscriptionSet). If there are no matching subscribers, then the SubscriptionSet will be empty and thus the newly received publication is added to the PublicationStore of broker 315. Note, in the distributed case a subscriber may be another broker.

If the SubscriptionSet is not empty, i.e. one or more subscribers have registered an interest in publications of the type just received, then the publication is forwarded to those subscribers. As indicated above, such subscribers may be other brokers.

Each broker also implements the following additional pseudo code:

```
// This method is invoked when a broker receives a subscription
request through the network
  processSubscription(subscriber s, subscription_data sd)
    add (subscriber s, subscription_data sd) to SubscriptionSet
    for all publications m in PublicationStore
      if m matches sd
        send m to subscriber
```

Thus, when a subscription request sd is received from a subscriber s at a broker, the subscription request is processed. This involves adding the subscription to the SubscriptionSet. Then the PublicationStore is searched to determine whether there are any publications m in the PublicationStore which match the newly registered subscription sd. If there are, then these are forwarded onto the subscriber.

Of course, the publication store may be scanned periodically in order to see whether there are any publication(s) contained within that may be forwarded onto a subscriber(s). It should thus now be appreciated that the present invention is applicable to the cases of both distributed and non-distributed brokers.

Having discussed the basic componentry and processing involved in the present invention, in accordance with an aspect, a motivation for ensuring that each publication is received by at least one subscriber will now be described.

Many large-scale enterprises make use of distributed messaging and publish/subscribe systems in which applications can attach to an arbitrary message broker within a network for the purpose of producing or consuming messages. The task of such a system is to pass messages from producers (publishers) to consumers (subscribers), which will, in general, be at different points in the network. Such messaging systems are asynchronous, in that the producer does not have to synchronize with the consumer; rather, the producer delegates responsibility for delivering each message to the messaging system, and the actual delivery of the message from the messaging system to the consumer will occur at some later time.

The asynchronous nature of such messaging systems gives them important advantages, such as the capability to support very high scalability. However, there is an important price to pay: whilst a particular messaging implementation may be able to offer assurances that messages will not be lost or discarded, it is not possible to provide to a producer application an assurance that the message will actually be delivered to a consumer. For example, in a network of WebSphere MQ queue managers, the consumer attaches by specifying a queue that exists on the queue manager to which it connects. A producing application in some other part of the network may send a message to a queue that it believes exists on queue manager M, but when the message later arrives on queue manager M, the queue may no longer exist. Other exception conditions that may cause a message to be undeliverable in the WebSphere MQ product are documented in the WebSphere MQ 5.3 manual “Application Programming Reference”, Chapter 7 “Dead-letter header”.

In such circumstances, the messaging system must invoke some form of exception handling. In particular, in the case of a system (such as WebSphere MQ) that offers “assured delivery”, the messaging system is not permitted to discard the undeliverable message, but must find something else to do with it that allows the user to discover it and respond appropriately (such as by redirecting the message to an alternative destination). One prior art solution is that the message is placed on an “exception destination” or “dead letter queue” (DLQ), which is a pre-defined point-to-point destination, local to the message broker on which the message was discovered to be undeliverable. The undeliverable message, when placed on the exception destination, is augmented with information describing the exception condition that caused the message to be undeliverable; the augmented message is referred to as an exception message. See http://www-306.ibm.com/software/integration/mqfamily/library/manualsa/csqsaw00/csqsaw0049.htm.

It is not a requirement that each queue manager has its own DLQ but it is a normal configuration in order to minimise the impact of an undeliverable message. It should be noted, that a DLQ is used when an error occurs. The absence of subscribers for a particular received publication is not considered to be an error. Thus there is no determination as to whether there are any registered subscribers.

Two existing known alternative solution are i) For message brokers neighboring the message broker on which the exception condition occurred to shut down communication with it, retaining messages intended for the message broker locally, pending some sort of user intervention to resolve the exception condition. This generates an outage whose scope is typically much larger than that of the original exception condition; most users therefore prefer to use exception destinations. ii) To report the message and to send the exception back to the requestor/originator.

A feature in all the exception handling scenarios discussed above is that when properly organized, there remains PRECISELY ONE copy of the message (in one of various forms: original, report, DLQ). Thus when the exception handling resolves the reason for the exception, the message will be processed exactly once.

The problem with using exception destinations is that in a messaging network of n message brokers there will be at least n exception destinations, each of which, in a high-service-level environment, the user must monitor, and whose contents must be processed. Exception messages are separated onto the various exception destinations according to the location in which the exception condition occurred (or was discovered).

However, this is just one possible way in which the user may prefer to divide up the task of managing the exception messages. Perhaps more likely is that the user has different operational procedures for processing exception messages according to the type of exception that occurred, or the type of original message, or even some particular value inside the message.

For example, one can imagine a system in which the handling for exception messages varies according to a “AccountClass” field in the message, where those with a value of “Platinum” are handled using the “call the customer and apologize profusely” procedure, and those with a value of “Blue” may be logged and forgotten. The only way the user can process these different messages differently, is by configuring applications with the correct filters (subscription requests) against each exception destination in the network. The likelihood is that the user has different applications corresponding to the different message classes, each living in some particular place; however, today's messaging systems provide no help in routing exception messages to the locations of these applications.

The solution to this is to use the technology described above. The messaging system has a single exception destination, called simply the exception destination, which is a system (i.e. not user-defined) object that may be a localized (but is preferably a non-localized) retentive non-arbitrating destination. In other words, a broker or network of brokers is used. The user is permitted to register applications called exception handlers (subscribers) at any broker in a network. When the exception handler is registered, a filter (or subscription request) must be specified, that indicates which exception messages are to be routed to this particular exception handler. The filter is a function of the content of the exception message, which includes the original undeliverable message augmented with a description of the exception condition. When an exception handler is registered, the broker attaches that application as a consumer to the exception destination, using the filter supplied.

Ordinary pub/sub provides therefore a flexible mechanism for routing exception messages. However, the problem with ordinary pub/sub is the possibility that messages will be lost if no one is around to receive such messages. With exception messages in particular, it is important that such messages are not lost.

The technology described previously provides the ideal solution. According to the defined behavior of retentive non-arbitrating destinations, any exception message generated when no exception handlers are registered is retained at the point in the network where it is generated. When an exception handler is registered, then messages matching its filter are sent to it, both in the case of newly generated messages, and any previously-generated messages that have been retained at any broker in the network.

It is now simple for the user to implement the Blue and Platinum exception handlers mentioned above. The Platinum exception handler can be located close to the call centre application that will generate the calls to the customers whose messages have generated exceptions. The Blue exception handler can be located on a machine with a suitable tape drive used to log the messages. Exception messages, no matter where in the network they are generated, will be correctly routed to the two exception handlers according to their associated filters. When the tape drive is taken off-line for servicing, the Blue exception handler can be deregistered, so that exception messages are retained within the network at their point of generation. When the tape drive is brought back online, the exception handler can be re-registered, and it will receive all matching exception messages generated in the intervening period. If it is decided that Platinum exceptions should be both logged and sent to the call centre application, then the logging exception handler's filter can be modified to match both Blue and Platinum messages; Platinum messages will then be received by both exception handling applications.

Note, exceptions may not just be as a result of an undeliverable message. For example, an exception may be generated when a disk is in danger of filling up etc. It should be appreciated, that using the retentive non-arbitrating solution described above, it is highly likely that more than one subscriber will receive the same exception message. What is crucial however, is that if no one is registered to receive a particular exception message, that message will be retained in order to ensure that a subsequently registering subscriber will receive access to the message.

In the exception message processing example provided, the possibility of multiple subscribers receiving the message is not problematic. There are certain circumstances under which one would be happy for more than one consumer to process the same exception message:
a) The cost of the duplication is low;
b) The exceptions represent some kind of emergency, and thus it is desirable for subscribers (e.g. service agents responsible for processing exceptions) to race one another; or
c) The cost of the intelligent routing that would otherwise be required is high, for example, the difficulties entailed in maintaining an up-to-date database of service agents' skills, knowing their whereabouts at any given time, and matching both of these to the particular exception event that has occurred to determine who should process the exception.

However, there are other circumstances where it is preferable that one subscriber should be designated as “definitive consumer”. In other words, one consumer should specifically be told to process the message.

These circumstances may arise in the case of handling an exception message and in other cases. Where the exception handling will correct the error and ‘liberate’ the original message (e.g. recreate it out of the DLQ message and reinsert in appropriate queue) it is essential this is done precisely once to maintain the once-and-once-only semantics. Such circumstances are not limited to exceptions. They may arise outside exception processing; for example when a stock trade is to be actioned by precisely one trader, but other traders are interested to know that the trade is being made.

In such circumstances the broker to which a subscriber attaches informs a subscriber when they are to be the “definitive consumer” of a particular message/type of message. The broker's choice may be made at random. Alternatively, subscribers may inform the broker of their capabilities at subscription time (or separately). In a yet further alternative embodiment, rules may be provided at the broker which can be used to determine whether a subscriber is capable of being designated “definitive consumer”. In such a yet further alternative embodiment, it may be necessary to provide information to the broker at subscription time as input to such rules. For example, a subscriber may indicate processing power, current workload etc. Such information may be used by the broker to determine whether a subscriber may safely be designated as the “definitive consumer”.

A subscriber not designated as the “definitive consumer” may instead be designated as a subscriber receiving published messages “for information only (FIO)”. FIO subscribers may use such messages for record keeping purposes. They may also be useful in the event that the definitive consumer fails—in which case, valuable information is not lost.

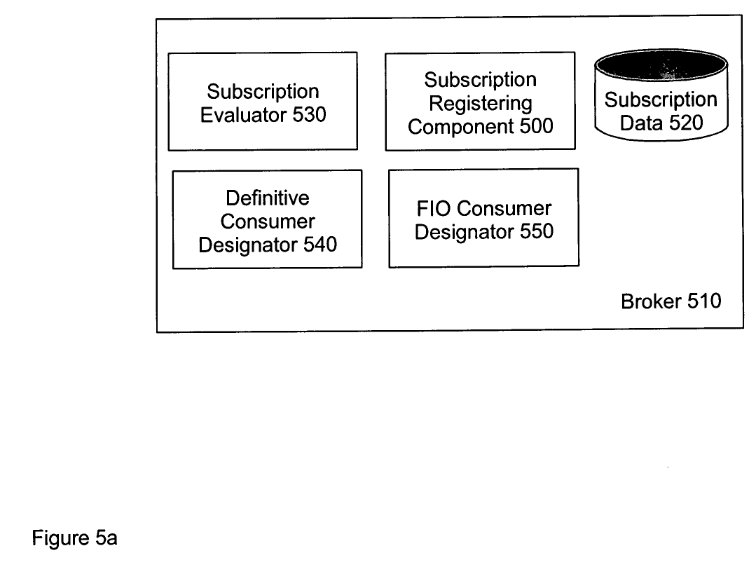

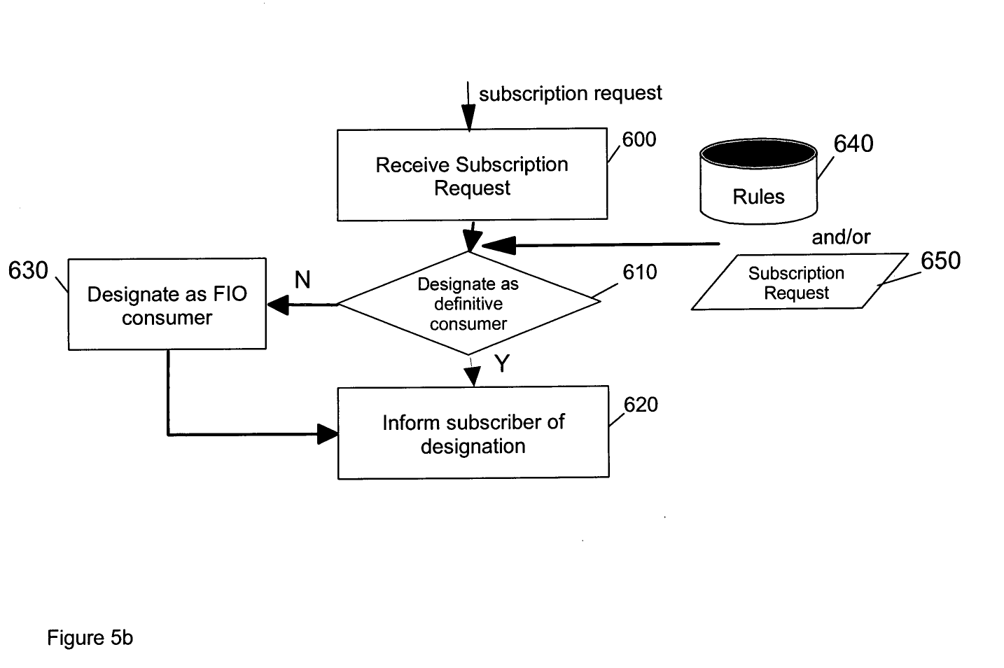

Subscribers may inform a broker to which they are attaching that they want to be FIO subscribers or rules may be used at the broker to make such a determination. FIGS. 5a and 5b illustrate the components and processing involved in designating a subscriber as either a definitive consumer or a FIO consumer. Only the parts of the broker relevant to this particular aspect are shown. Broker 510 comprises a subscription registering component 500 which receives subscription requests and stores them as subscription data 520. Thus when a subscription request is received (step 600), it is determined by subscription evaluating component 530 whether the provider of the subscription request (the subscriber) should be designated as the “definitive consumer” (step 610). The decision may be made using input such as rules 640 at the broker and/or information received as part of the subscription request 650. If it is determined that the subscriber should be “the definitive consumer”, then definitive consumer designator 540 informs the subscriber of this fact (step 620). If on the other hand, the subscriber is not to be designated as the definitive consumer, then it is decided that the subscriber is an FIO consumer (step 630). The subscriber is then informed of this fact (step 640) by the FIO consumer designator 550.

Note, in another embodiment the decision as to who should be a definitive consumer and who should be a FIO consumer is made on a per received publication basis. This decision may be on a round robin basis or could be made using some intelligent logic—for example information based on subscriber workload, other information received from subscribers, rules at the broker.

The decision may be periodically updated. For example, when a subscriber de-registers. There are three classes of subscribers:

a) BOTH:
willing/able to process messages as a “definitive consumer” and wishes to be informed of all messages even if not the “definitive consumer”. A consumer of type both only receives a single copy of each message.

b) PROCESSOR:
willing/able to process messages as a “definitive consumer”, but does not wish to hear about messages when not designated as “definitive consumer”.

c) LISTENER:
not willing/able to process messages as a “definitive consumer”, but does wish to be informed of a 11 messages.

As described above, when there are a plurality of subscribers registered to receive a particular message, then it is useful to designate one subscriber as the “definitive consumer” and for the others to be FIO subscribers (listeners). The choice of a definitive consumer can be made from those subscribers of type processor and both. A subscriber of type both who is not designated as a definitive consumer will be selected as an FIO consumer.

Occasionally there will be no matching subscribers for a message and the message will therefore be retained until a matching subscriber registers (step 220, 270—FIGS. 2a, 2b). Even in such a circumstance, the idea of a “definitive consumer” can still be useful. This is because a subscriber will be unaware as to who else has received a particular message. Thus even though a subscriber may be the only receiver of a message, the subscriber will not know this. Thus it is useful for a single subscriber receiving a message to be designated as the “definitive consumer”. Note, in some circumstances such a single subscriber may not be deemed suitable by the broker. In which case, the message may be sent out FIO and a copy of the message may still be retained at the broker until a subscriber suitable to act as a “definitive consumer” registers.

Note, there may be multiple classes of definitive consumer. For example, when an order arrives, it should be processed by precisely one ‘accounts’ subscriber (to action charging), and precisely one ‘stockroom’ subscriber (to action collection/packing). There may also be other non-definitive subscribers, either in these departments or elsewhere (e.g. marketing).

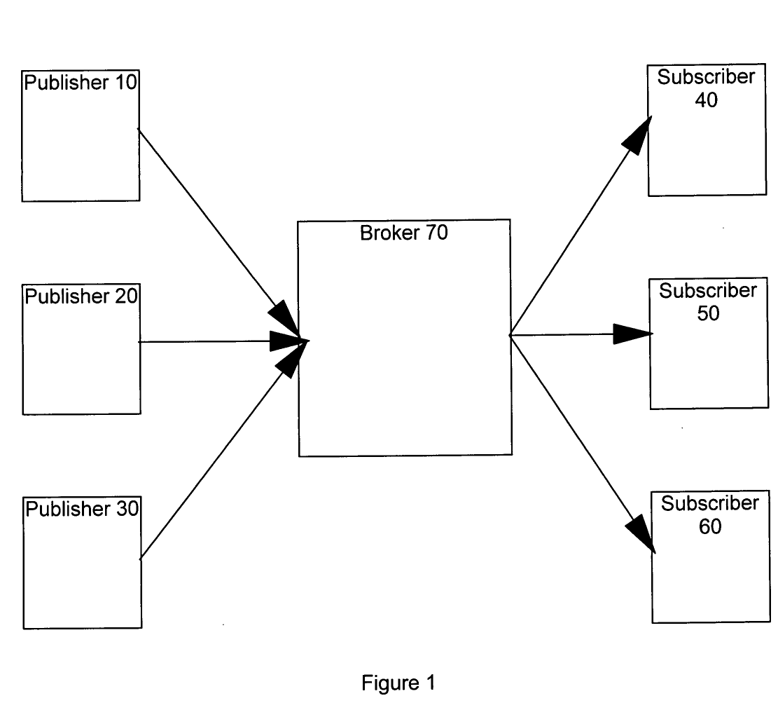

Further note, a separate broker functionality has been described throughout (see for example FIGS. 1, 2, 4, 5a). However this is not necessarily the case. Broker functionality may, for example, be provided as part of a publisher.

Finally, a check may be made as to whether a definitive consumer actually processed a message. For example, the broker may ask a definitive consumer to confirm that the message has been processed. Further, if there is no subscriber capable of being the definitive consumer, then a publication may be forwarded onto FIO subscribers and retained until a definitive consumer is designated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for a broker to assure that a publication received from a publisher is transmitted to at least one subscriber, the method comprising:
receiving a publication from a publisher; and
retaining the publication in storage at least until the publication is delivered successfully to a subscriber in response to determining that there are no registered subscribers for the received publication.

2. The method of claim 1 further comprising:
receiving a subscription request from a subscriber;
determining whether the retained publication satisfies the subscription request; and
removing the retained publication from storage and transmitting the retained publication to the subscriber in response to determining that the retained publication satisfies the subscription request.

3. The method of claim 1 further comprising:
periodically determining whether it is possible to forward a retained publication to any registered subscriber.

4. The method of claim 1, wherein the received publication is an exception message.

5. The method of claim 1 further comprising:
designating a subscriber as a “definitive consumer”, wherein the designated “definitive consumer” is responsible for processing at least one publication.

6. The method of claim 5 further comprising:
determining who to designate as a “definitive consumer” responsible for processing the publication for each publication received.

7. The method of claim 5 further comprising:
periodically determining who to designate as a “definitive consumer”.

8. The method of claim 5 further comprising:
determining whether the subscriber should be designated as a definitive consumer upon receipt of a subscription request.

9. The method of claim 5 further comprising:
using information received from a subscriber to determine whether to designate the subscriber as a “definitive consumer”.

10. The method of claim 5 further comprising:
using rules at the broker to determine whether to designate the subscriber as a “definitive consumer”.

11. The method of claim 1 further comprising:
designating a subscriber as a “for information only” (FIO) subscriber, a FIO subscriber receiving at least one publication for information only.

12. The method of claim 11, comprising:
upon receipt of a subscription request, determining whether the subscriber should be designated as a FIO consumer.

13. The method of claim 11 further comprising:
using information received from a subscriber to determine whether to designate the subscriber as a FIO subscriber.

14. The method of claim 1 further comprising:
determining that there are no subscribers suitable to be designated as a definitive consumer for a received publication;
forwarding the received publication onto subscribers having registered an interest in such publications;
retaining a copy of the publication until a subscriber suitable to be designated a definitive consumer registers.

15. The method of claim 1, wherein retaining the publication in storage at least until the publication is delivered successfully to a subscriber comprises:
retaining the publication in storage until it is confirmed that the publication has been processed.

16. An apparatus for a broker to assure that a publication received from a publisher, is transmitted to at least one subscriber, the apparatus comprising:
means for receiving a publication from a publisher; and
means for retaining the publication in storage at least until the publication is delivered successfully to a subscriber in response to determining that there are no registered subscribers for the received publication.

17. The apparatus of claim 16 further comprising:
means for receiving a subscription request from a subscriber;
means for determining whether the retained publication satisfies the subscription request; and
means for removing the retained publication from storage and transmitting the retained publication to the subscriber in response to determining that the retained publication satisfies the subscription request.

18. The apparatus of claim 16 further comprising:
means for periodically determining whether it is possible to forward a retained publication to any registered subscriber.

19. A computer program product for a broker to assure that a publication received from a publisher is transmitted to at least one subscriber, said computer program product comprising:
a computer usable medium having computer useable program code embodied therewith, the computer useable program code comprising:
computer usable program code configured to receive a publication from a publisher; and
computer usable program code configured to retain the publication in storage at least until the publication is delivered successfully to a subscriber in response to determining that there are no registered subscribers for the received publication

20. The computer program product of claim 19 further comprising:
computer usable program code configured to receive a subscription request from a subscriber;
computer usable program code configured to determine whether the retained publication satisfies the subscription request; and
computer usable program code configured to remove the retained publication from storage and transmitting the retained publication to the subscriber in response to determining that the retained publication satisfies the subscription request.
